(19) United States
(12) Patent Application Publication
(10) Pub. No.: US 2024/0101233 A1
(43) Pub. Date: Mar. 28, 2024

(54) DEVICE FOR THE LAUNCH AND RECOVERY OF LARGE DIAMETER UNCREWED UNDERWATER VEHICLE

(71) Applicant: Huntington Ingalls, Inc., Newport News, VA (US)

(72) Inventors: Gregory W. Horshok, Pascagoula, MS (US); John A. Johnson, Pascagoula, MS (US); Jason May, Pascagoula, MS (US)

(21) Appl. No.: 18/373,174

(22) Filed: Sep. 26, 2023

Related U.S. Application Data
(60) Provisional application No. 63/410,531, filed on Sep. 27, 2022.

(51) Int. Cl. B63C 1/12

(52) U.S. Cl. CPC B63C 1/12

(57) ABSTRACT

A launch and recovery vehicle can be towed by a water vehicle or ship. The launch and recover vehicle can ballast in order to retrieve an unmanned vehicle. The launch and recovery vehicle can deballast while holding the unmanned vehicle. The water vehicle or ship can retrieve or winch the launch and recovery vehicle onto a well deck. Additionally, the launch and recovery vehicle has wheels and can be pulled or towed onto land with a land-based vehicle, such as a truck.

### CROSS-REFERENCE TO RELATED APPLICATIONS

This application claims the benefit of U.S. application Ser. No. 63/410,531, filed on Sep. 27, 2022, which is included herein in its entirety.

### BACKGROUND

There are currently no viable solutions for bringing a Launch and Recovery of Large Diameter Uncrewed Underwater Vehicle (LDUUV) onto or into a ship. LDUUV is also known as a Large Diameter Unmanned Underwater Vehicle. The LDUUVs are too large for J-davits or A-frame davits, and existing boat recovery systems are not compatible. A heavy duty telescoping overhead crane on the Independence Class Littoral Combat Ships (LCS) platform has been used but is a time consuming operation, along with that specific Uncrewed/Unmanned Underwater Vehicle (UUV) program subsequently having been canceled. Past LDUUV demonstrations with Navy assets have the LDUUV being launched and recovered from a ship's flooded well deck. This method involved a high level of risk as the LDUUV could not be satisfactorily controlled during approach to its trailer due to wave action and turbulence inherent in a flooded well deck. During a previous demonstration with a different launch and recovery system in a flooded well deck, the Command Officer of the ship canceled the evolution due to safety concerns.

### SUMMARY

This system launches and recovers LDUUVs from an amphibious well deck where the vehicle can be winched in with an existing system onboard the ship. The system does not require the well deck to be flooded, and provides better control of the vehicles while eliminating time-consuming ship ballasting operations.

A launch and recovery vehicle is provided that includes a frame having connected materials that collectively form a rigid body. The frame is elongated and has a set of wheels to carry an item. The frame is pulled or towed on the set of wheels when the frame is located on a solid surface. The frame can be immersed into water to retrieve the item, which is in the water. The frame has a section that is an interior cavity or a middle area with a semi-circular or similar shape to hold the item in the section of the frame. A capture mechanism includes a pair of rails that run along each side of the frame. The capture mechanism secures the item to the frame. The frame has at least a tank for ballasting and deballasting such that when ballasting occurs and the launch and recovery vehicle is in the water, the launch and recovery vehicle submerges in the water, and when deballasting occurs and the launch and recovery vehicle is in the water, the launch and recovery vehicle rises toward the surface in the water.

### BRIEF DESCRIPTION OF THE DRAWINGS

The present disclosure is directed to a launch and recovery vehicle, which is described in detail below with reference to the attached drawing figures, which are incorporated herein by reference.

FIG. 1 is an exemplary illustration of a frontal view of a launch and recovery vehicle holding an unmanned vehicle, in accordance with an embodiment of the present disclosure;

FIG. 2 is an exemplary illustration of a lateral view of a launch and recovery vehicle holding an unmanned vehicle, in accordance with an embodiment of the present disclosure;

FIG. 3 is an exemplary illustration of a lateral view of a launch and recovery vehicle without the unmanned vehicle, in accordance with an embodiment of the present disclosure;

FIG. 4 is an exemplary illustration of a frontal view of a launch and recovery vehicle without the unmanned vehicle, in accordance with an embodiment of the present disclosure;

FIG. 5 is an exemplary illustration of a frontal view of a launch and recovery vehicle with the unmanned vehicle, in accordance with an embodiment of the present disclosure;

FIG. 6 is an exemplary illustration of a rear view of a launch and recovery vehicle with the unmanned vehicle, in accordance with an embodiment of the present disclosure;

FIG. 7 is an exemplary illustration of a frontal view of a launch and recovery vehicle showing a semi-circular shape that holds the unmanned vehicle, in accordance with an embodiment of the present disclosure;

FIG. 8 is an exemplary illustration of an angle view of a launch and recovery vehicle showing a semi-circular shape that holds the unmanned vehicle, in accordance with an embodiment of the present disclosure;

FIG. 9 is an exemplary illustration of an angle view of a launch and recovery vehicle showing a set of rails, in accordance with an embodiment of the present disclosure;

FIG. 10 is an exemplary illustration of an angle view of a launch and recovery vehicle showing a cradle for supporting the unmanned vehicle, in accordance with an embodiment of the present disclosure;

FIG. 11 is an exemplary illustration of a top view of a launch and recovery vehicle with the unmanned vehicle, in accordance with an embodiment of the present disclosure;

FIG. 12 is an exemplary illustration of an angle view of a launch and recovery vehicle with the unmanned vehicle, in accordance with an embodiment of the present disclosure;

FIG. 13 is an exemplary illustration of a top view of a launch and recovery vehicle having ballast tanks and holding the unmanned vehicle, in accordance with an embodiment of the present disclosure;

FIG. 14 is an exemplary illustration of an angle view of a launch and recovery vehicle having ballast tanks and holding the unmanned vehicle, in accordance with an embodiment of the present disclosure; and

FIG. 15 is an exemplary illustration of a sectional view of a launch and recovery vehicle with a latching mechanism for stopping the unmanned vehicle that is moving into position, in accordance with an embodiment of the present disclosure.

### DETAILED DESCRIPTION

Embodiments of the present disclosure are directed to an at-sea towable, 4-wheeled, aluminum vehicle designed to safely launch and recover UUVs off of a well deck capable amphibious ships or at suitable land locations. The launch and recovery vehicle is an unmanned system, capable of being remotely controlled to ballast and deballast via air tanks onboard or remotely-tethered air supply. Ballasting capability allows the launch and recovery vehicle to achieve a desired depth in order to retrieve an LDUUV operating near the water's surface. A deballasting capability allows the launch and recovery vehicle to safely raise the LDUUV out of the water to be safely towed into a ship's dry well deck or ashore. Special features include the ability to be towed behind a ship, interchangable bunks, bow stops, floatation tanks to accommodate different diameter and weighted UUVs, and front wheels that can be either steered or locked in place.

Other embodiments describe a towable rolling variable-draft floating dry dock, which can be deployed with ships. These ships include a large well deck and have the capability to ballast for the launch and recovery of amphibious land crafts. The embodiments of the present disclosure can use the capability of the ships to launch and recover unmanned vehicles under tow in the water behind the ship. For example, the embodiments in the form of a launch and recovery vehicle can be winched onto the well deck of a ship. In those embodiments, an implementation will include the launch from and return to a ship's well deck, launch and recovery of an unmanned vehicle from the water while under tow, and secure, store and maneuver of the unmanned vehicle inside the ship.

Embodiments of the present disclosure does not require a ship to flood the well deck, thereby providing better launch and recovery control. Additionally, there is no risk of recovery asset/vehicle damage as the well deck is not full of unstable water, causing control of the vehicle to be predictable. In embodiments, one may find the use of commercial scuba tanks, valves, hoses, regulators, axels, wheels, and batteries.

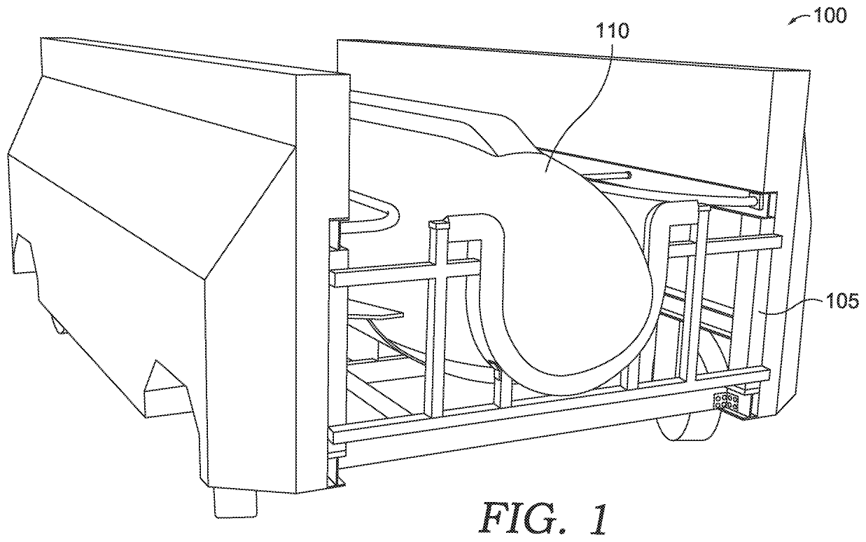

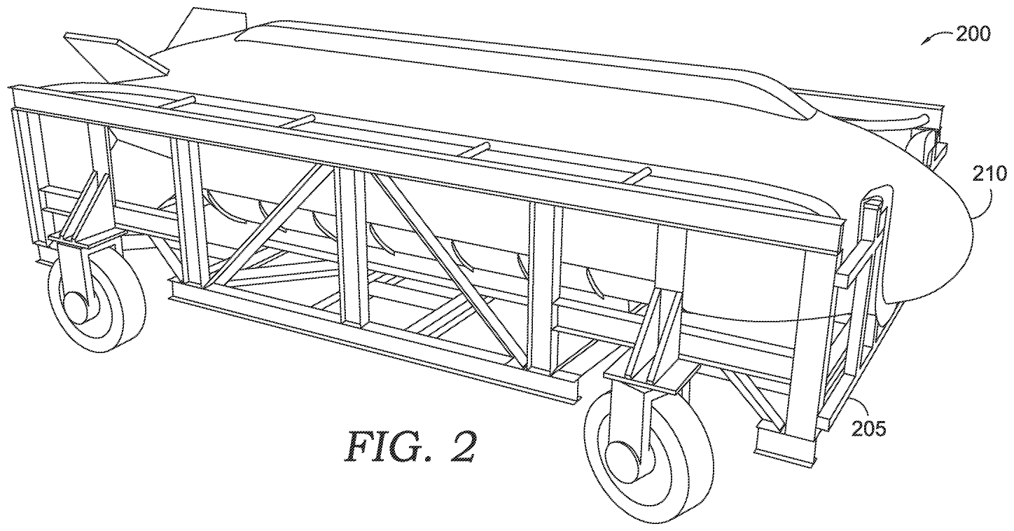

In FIG. 1, an operational view 100 of a launch and recovery vehicle 105 carrying an unmanned vehicle (UV) 110. FIG. 2 illustrates an operational view 200 of a launch and recovery vehicle 205 carrying an unmanned vehicle 210.

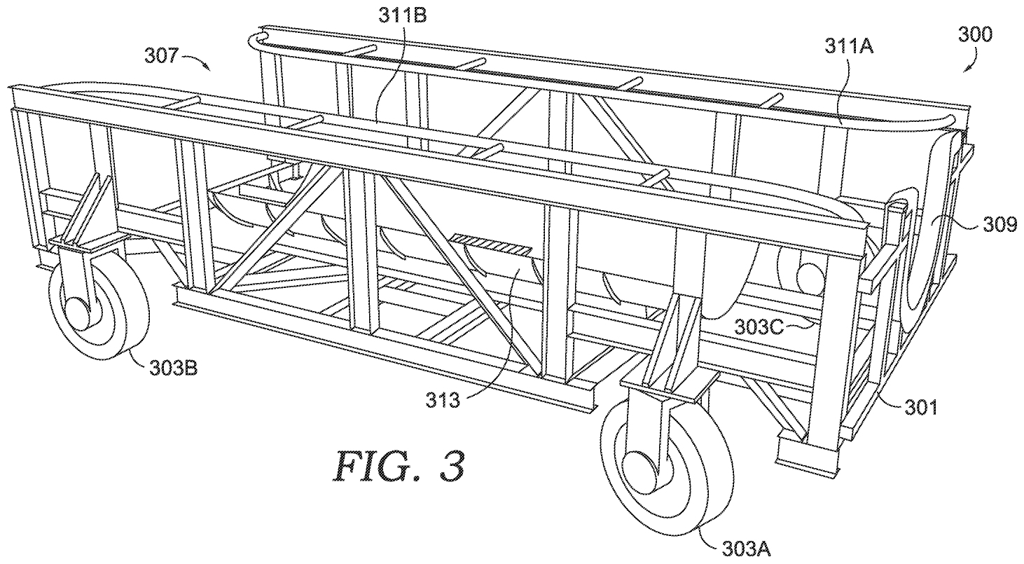

Turning now to FIG. 3, a launch and recovery vehicle 300 is shown with a frame 301 that includes connected material that form a rigid body. Frame 301 is similar to launch and recovery vehicles 105 and 205. Frame 301 can be constructed out of a variety of materials, including metals that can be held together through any number of ways to connect. For example, the materials can be welded together or the materials can be connected together by screws. The idea is to have frame 301 form an elongated rigid body that can carry a heavy weight and can withstand waves or withstand being tossed around in the water.

Frame 301 includes a set of wheels (303A, 303B, and 303C), which allows for frame 301 to roll around on a solid surface. A fourth wheel is also provided, but not shown in FIG. 3. The wheels allow for frame 301 to be pulled or towed. The wheels are capable of spinning in 360 degrees, which allow frame 301 (or the launch and recovery vehicle) to move in a variety of directions when located on a solid surface (i.e. land). Additionally, the wheels can be locked in placed to prevent spinning so that the wheels only roll in one direction. Finally, the wheels can be configured where two wheels (typically at the rear) can be locked into positioned and the other two wheels (typically at the front) can continue to spin in a number of different directions. This allows the launch and recovery vehicle to be towed on a surface, making turning with the launch and recovery vehicle easier. As one of ordinary skill in the art knows, a land-based vehicle (e.g. truck) may hitch the launch and recovery vehicle (which includes frame 301) at the location with the spinning wheels, although the hitch can be placed at the opposite side of the launch and recovery vehicle where the fixed wheels are located.

Frame 301 also includes an interior cavity 307, which is an area in the middle of frame 301. In some embodiments, the interior cavity 307 can be a space to carry the unmanned vehicle as shown in FIGS. 1 and 2. The interior cavity 307 can have a portion that is a semi-circular shape 309 or similar shape in order to hold the unmanned vehicle. The portion that is semi-circular shape 309 may be made of materials different from the materials that make up frame 301. For example, semi-circular shape 309 may be made of material that is flexible in order to avoid damaging the unmanned vehicle when it rests in frame 301.

In addition, frame 301 has a set of rails 311A and 311B that run along the length of frame 301. Rails 311A and 311B aid in the process of holding the unmanned vehicle in place in frame 301. In embodiments, rails 311A and 311B move up and down and are adjustable in nature.

Additionally, rails 311A and 311B can lock in either the up or down positions. In the up position, rails 311A and 311B touch the unmanned vehicle in a way so that the rails 311A and 311B hold the unmanned vehicle and secures it to frame 301.

In the region for the interior cavity 307, a cradle 313 is located to support the unmanned vehicle. As one of ordinary skill in the art understands, the unmanned vehicle must be secured to frame 301. With the interior cavity 307, shape 309, rails 311A and 311B, and cradle 313, the unmanned vehicle can be secured to frame 301. Although not shown, straps can be provided to aid in securing the unmanned vehicle to frame 301.

In embodiments, frame 301 can hold up to at least an equivalent of 20,000 pounds (or approximately 9071.8 kilograms). Other embodiments can be constructed to allow frame 301 to carry heavier weights. Additionally, frame 301 can withstand a momentum of at least 26,000 pounds from an unmanned vehicle. As one can imagine, the unmanned vehicle may be moving at a slow to high rate of speed as it engages frame 301 of the launch and recovery vehicle. The launch and recovery vehicle must be able to withstand a force from the momentum of the unmanned vehicle.

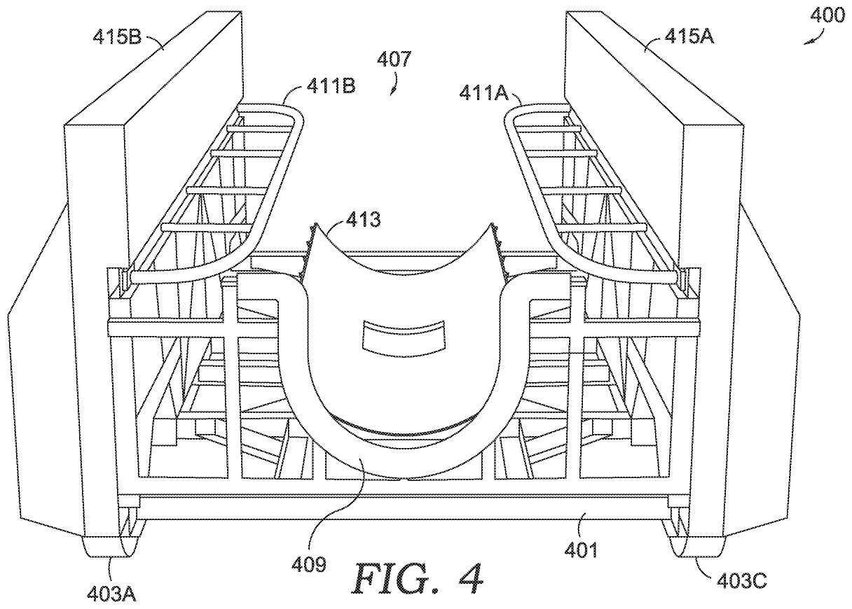

In FIG. 4, another view of a launch and recovery vehicle 400 is shown from a frontal perspective. Many of the items identified in FIG. 3 are shown in FIG. 4. For example, frame 401 is shown with wheels 403A and 403C in the frontal view. Additionally, there is a cavity 407, which is an area to hold the unmanned vehicle. There is a semi-circular shape 409 that is used to hold and secure one end of the unmanned vehicle. And, as found in FIG. 3, a cradle 413 is located in the area of cavity 407 in frame 401 to support the unmanned vehicle.

In embodiments, the launch and recovery vehicle 400 may have a tank 415A or 415B attached to frame 401. Tanks 415A and 415B can be used for ballasting or deballasting the entire launch and recovery vehicle 400. For example, if vehicle 400 is deployed in a water environment, a ballasting procedure can occur whereby air is released from tanks 415A and 415B to submerge launch and recovery vehicle 400 below the surface. Likewise, a deballasting procedure can occur where air is put into tanks 415A and 415B to raise a submerged launch and recovery vehicle 400 towards the surface. As one of ordinary skill understands, vehicle 400 can be towed into the water whereby it is submerged through the ballasting procedure. The unmanned vehicle can move into the cavity 407 until it rests in shape 409. Rails 411A and 411B can move to a position to secure the unmanned vehicle while it rests in cradle 413. At that point, the deballasting procedure can occur raising the entire structure of the launch and recovery vehicle 400 to the surface. The vehicle 400 can be towed by a water vehicle, such as a ship.

In some embodiments, although not shown, there may only be a single tank that allows for ballasting and deballasting. Rather than having tanks 415A and 415B, a single tank can be used and placed in the center of frame 401. For example, the single tank could be attached to the bottom of frame 401 or underneath cradle 413.

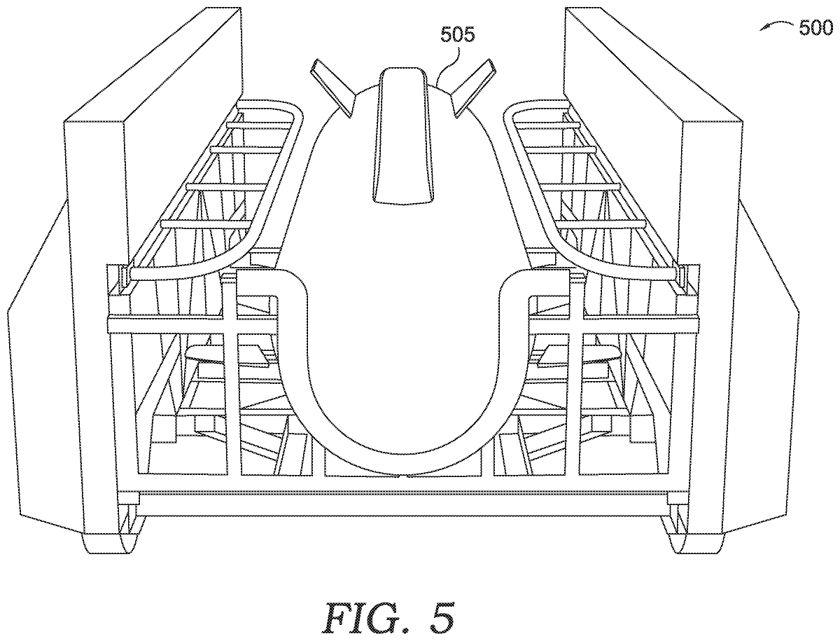

Turning now to FIG. 5, which is similar to the previous figures, an unmanned vehicle 505 is shown positioned in a launch and recovery vehicle 500. Launch and recovery vehicle 500 holds the unmanned vehicle 505 and is shown from a frontal perspective.

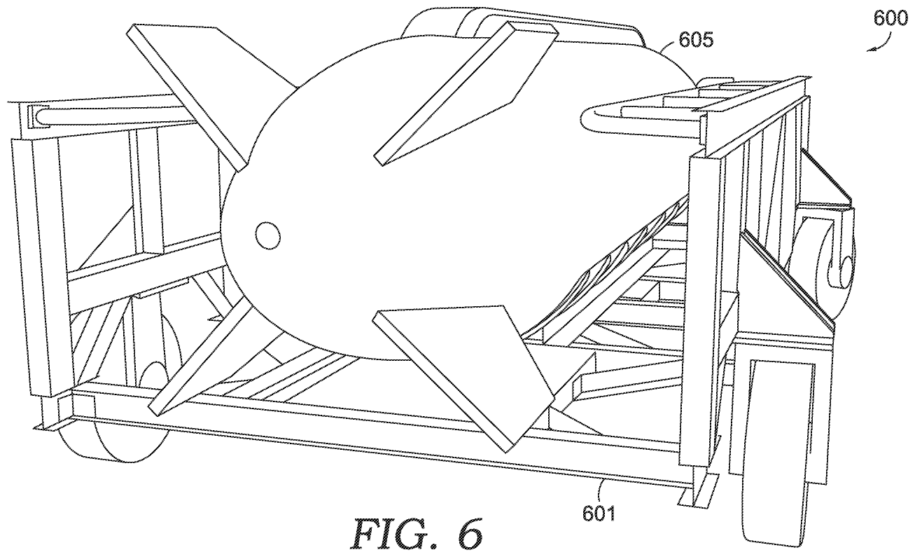

In FIG. 6, a launch and recovery vehicle 600 is shown from a rear perspective in relation to FIG. 5. Additionally, launch and recovery vehicle 600 does not show any ballast tanks as shown in FIGS. 4 and 5. In embodiments, during operation, the unmanned vehicle 605 enters frame 601 from a rear entry and moves parallel to frame 601 to rest in the position as shown.

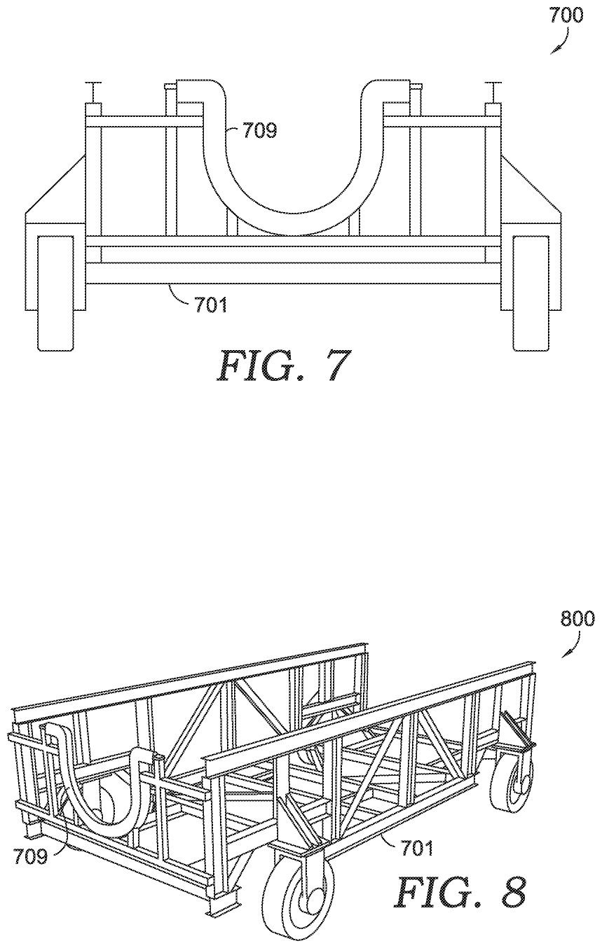

In FIG. 7, a frontal view of a launch and recovery vehicle 700 is shown. A frontal view of a frame 701 is shown with a semi-circular shape 709. As discussed earlier, shape 709 may be made of a different material than the materials used to make frame 701.

In FIG. 8, an angle view of the launch and recovery vehicle 800 is shown. A side angle view of frame 701 is shown with the semi-circular shape 709.

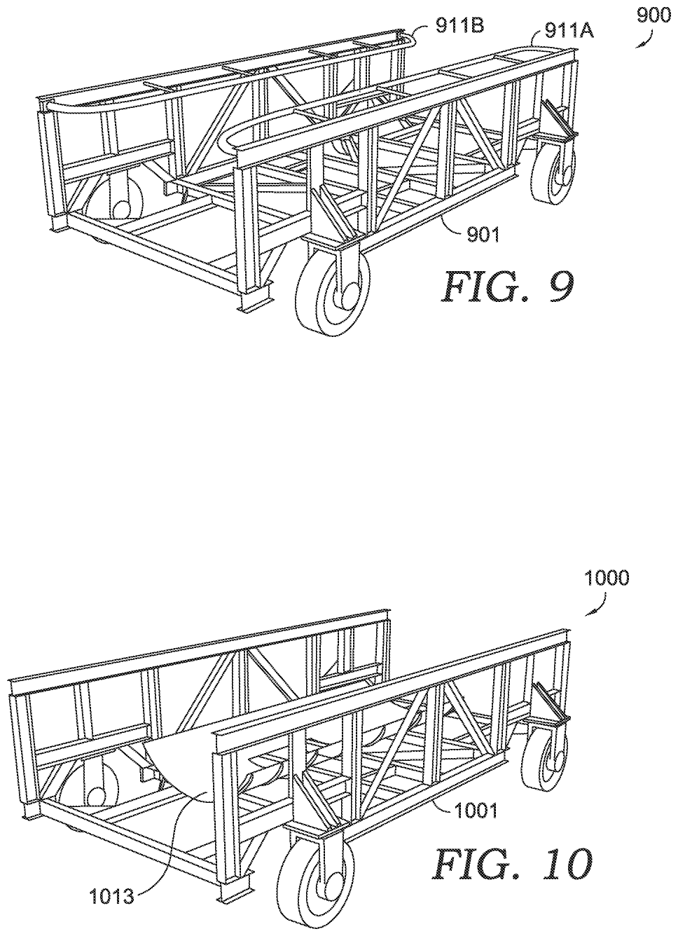

Turning now to FIG. 9, a launch and recovery vehicle 900 is shown with a frame 901 and rails 911A and 911B. As discussed earlier, rails can be moveable in order to adjust to secure the unmanned vehicle.

In FIG. 10, a launch and recovery vehicle 1000 is shown with a frame 1001 and cradle 1013. Cradle 1013 may be used to support the unmanned vehicle, like unmanned vehicles 110, 210, 505, and 605. As one can see, FIG. 10 is shown without any rails.

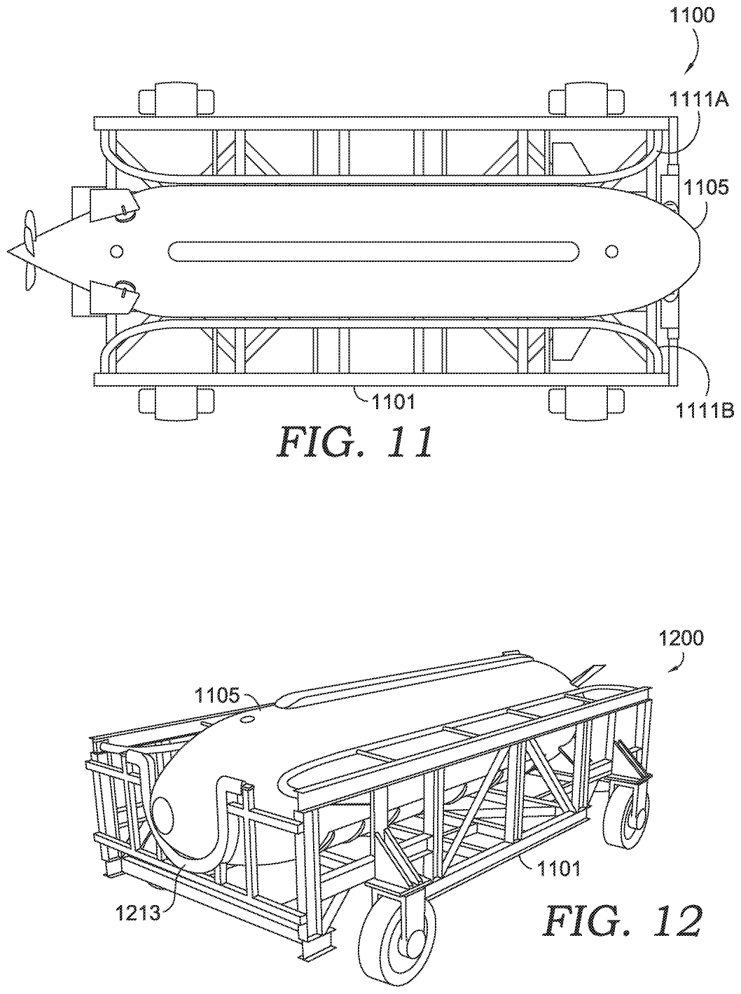

Turning now to FIG. 11, a top view of a launch and recovery vehicle 1100 is shown with an unmanned vehicle 1105. Rails 1111A and 1111B are shown in a position to secure unmanned vehicle 1105.

In FIG. 12, a launch and recovery vehicle 1200 shows frame 1101 in another perspective of a side angle view where unmanned vehicle 1105 rests its front or nose in semi-circular cradle 1213. The inventors have contemplated the use of flexible material for cradle 1213 to avoid damaging unmanned vehicle 1105 when they come in contact with each other.

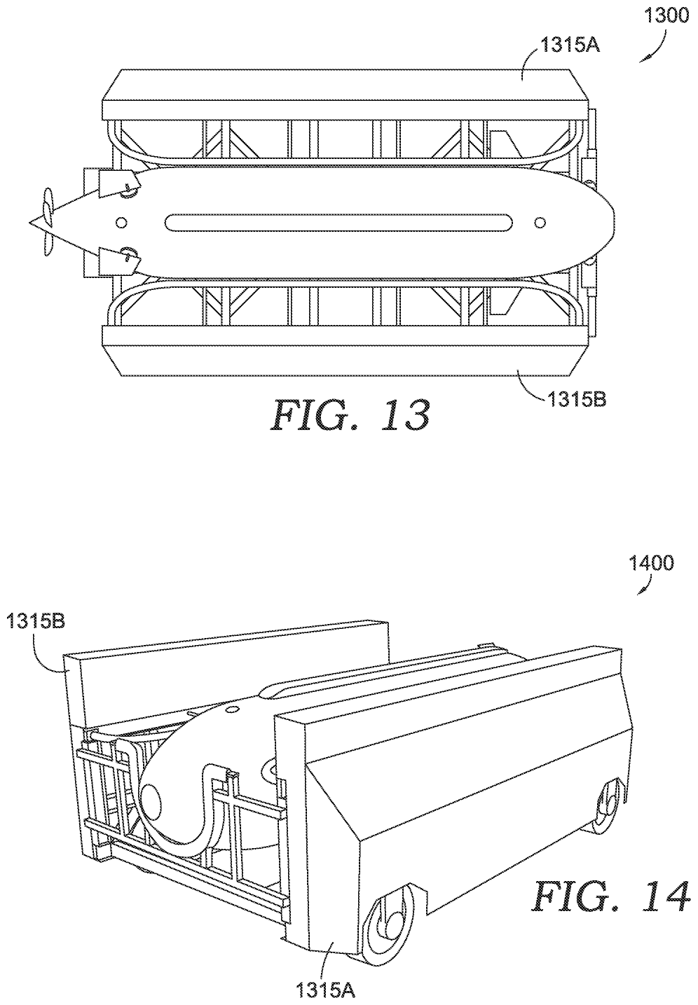

In FIGS. 13 and 14, launch and recover vehicles 1300 and 1400 are similar to launch and recovery vehicles 1100 and 1200 in FIGS. 11 and 12 with the exception of having ballast tanks 1315A and 1315B. Ballast tanks help submerge and raise the launch and recovery vehicle as needed.

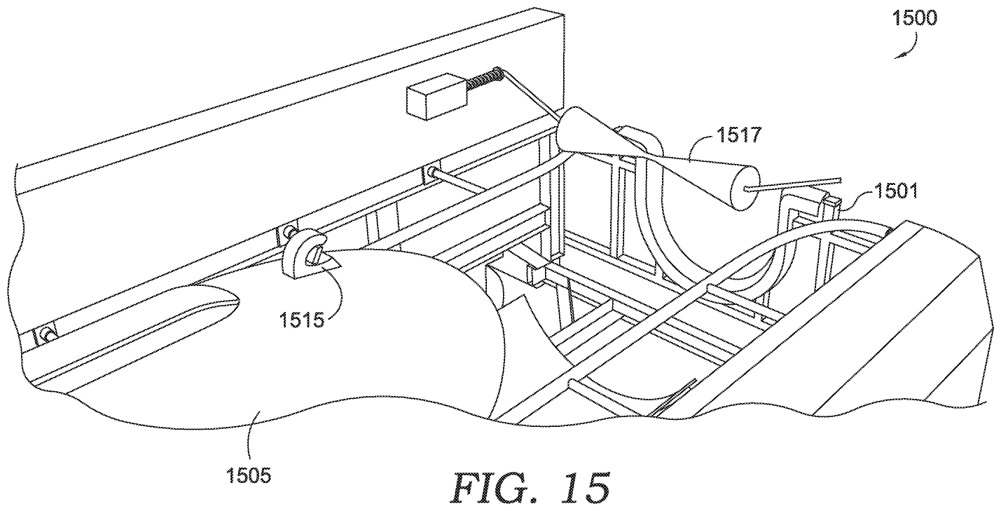

Turning to FIG. 15, a latching mechanism is shown in a sectional view of a launch and recovery vehicle 1500. In embodiments, an unmanned vehicle 1505 may be retrieved while in the water. When the launch and recovery vehicle 1500 is positioned to retrieve the unmanned vehicle 1505, the unmanned vehicle 1505 may slide parallel into a frame 1501. The unmanned vehicle 1505 may continue sliding into position until a latch 1515 encounters a cable device 1517. Once the latch 1515 connects to or snags the cable device 1517, the motion of the unmanned vehicle 1505 stops and the unmanned vehicle 1505 is secured into position in frame 1501. Additionally, the cable device may be a cable or similar structure that is connected to the walls or interior sides of frame 1501. Or, in other embodiments, the cable device may be connected to the interior walls of the ballast tanks. Even further, the cable device can be implemented with a trigger mechanism, which signals when the motion of the unmanned vehicle 1505 should stop.

Although FIG. 15 shows the use of a latching mechanism, the launch and recovery vehicle can be implemented in embodiments without the latching mechanism. In other embodiments, the unmanned vehicle would slide into place until it comes in contact with the semi-circular cradle. At that point, the unmanned vehicle would stop any further movement.

As discussed above, implementations of embodiments of the present disclosure will include launching the unmanned vehicle off the stern of a ship, and ballasting the launch and recovery vehicle down to launch the unmanned vehicle from the launch and recovery vehicle. The recovery will include capturing the unmanned vehicle in the ballasted-down launch and recovery vehicle, deballasting, and then pulling the launch and recovery vehicle up into the well deck of the ship or other type water vehicle.

Turning to other aspects, the launch and recovery vehicle may be loaded and unloaded through the well deck through a stern gate of the ship. To load the launch and recovery vehicle onto the ship, the launch and recovery vehicle may be facing outboard (perpendicular to the ship's centerline) and may need to make a 90 degree turn into the well deck. Alternatively, the launch and recovery vehicle can be placed onto or towed onto a floating dock connected to the stern gate so that the launch and recovery vehicle approaches parallel to the ship's centerline. Additionally, when the launch and recovery vehicle is located onto the floating dock, the launch and recovery vehicle can be rolled on its wheels.

Although, the term ship is used, other water vehicles may be used that have a similar structure with a well deck. And although the well deck may be located in the stern of the water vehicle, the well deck may be positioned in another location, such as the bow of the water vehicle.

As stated earlier, embodiments of the present disclosure are implemented to launch and recover an unmanned vehicle, which can be approximately 25 feet in length, 60 inches in diameter, and weighing approximately 8,750 pounds. The unmanned vehicle can carry a payload of up to 3,600 pounds in its interior compartment or in exterior mounted canisters. The unmanned vehicle can be a “wet” vehicle, meaning that the interior compartment can be flooded. When flooded, the unmanned vehicle could weigh as much as 20,000 pounds.

The present disclosure has been described in relation to embodiments, which are intended in all respects to be illustrative rather than restrictive. Many different arrangements of the various components depicted, as well as use of components not shown, are possible without departing from the spirit and scope of the present disclosure. Alternative aspects will become apparent to those skilled in the art that do not depart from the scope. It will be understood that certain features and subcombinations are of utility and may be employed without reference to other features and subcombinations and are contemplated as within the scope of the claims.

What is claimed is:

1. A launch and recovery vehicle, comprising:
a frame having a plurality of connected materials that collectively form a rigid body, wherein the frame is elongated and has a set of wheels to carry an item;
wherein the frame is pulled or towed on the set of wheels when the frame is located on a solid surface;
wherein the frame can be immersed into water to retrieve the item, which is in the water;
the frame having a portion that is a middle area with a semi-circular or similar shape at one end to hold the item in the portion of the frame;
a capture mechanism that includes a pair of rails that run along each side of the frame, the capture mechanism secures the item to the frame; and
the frame having at least one tank for ballasting and deballasting wherein when ballasting occurs and the launch and recovery vehicle is in the water, the launch and recovery vehicle sinks in the water, and when deballasting occurs and the launch and recovery vehicle is in the water, the launch and recovery vehicle rises toward a water surface in the water.

2. The vehicle of claim 1, wherein the item is an unmanned underwater vehicle.

3. The vehicle of claim 2, wherein the frame can hold up to at least an equivalent of 20,000 pounds.

4. The vehicle of claim 3, wherein the frame can withstand a momentum of at least an equivalent of 26,000 pounds from the item.

5. The vehicle of claim 1, wherein a material of the portion is flexible to avoid damaging the item.

6. The vehicle of claim 1, wherein each rail of the pair of rails moves in an up or down position and locks in either position.

7. The vehicle of claim 6, when the pair of rails is in the up position, the pair of rails touch the item such that the pair of rails and the portion hold the item and secure the item in the frame.

8. The vehicle of claim 1, wherein the portion includes a cradle to support the item.

9. The vehicle of claim 1, wherein the frame attaches to a water vehicle and is pulled or towed by the water vehicle when the frame is located in the water.

10. The vehicle of claim 1, wherein each of the set of wheels has a capability to spin perpendicularly 360 degrees relative to its planar rotation.

11. The vehicle of claim 10, wherein each of the set of wheels has a capability to lock in place to prevent spinning, but can continue its planar rotation.

12. The vehicle of claim 1, further comprising a latching mechanism that has a latch that engages a cable device when the item moves in a parallel manner into the frame, the cable device is positioned perpendicular to a lengthwise position of the frame and is attached to either interior side of the frame.

13. A method for a launch and recover vehicle, comprising:
creating a frame having a plurality of connected materials that collectively form a rigid body;
elongating the frame to carry an item;
adding a set of wheels to the frame where the frame is pulled or towed on the set of wheels when the frame is located on a solid surface;
immersing the frame into water to retrieve the item, which is in the water;
including a portion in the frame that is a middle area with a semi-circular or similar shape at one end to hold the item in the portion of the frame;
implementing a capture mechanism that includes a pair of rails that run along each side of the frame, the capture mechanism secures the item to the frame; and
attaching at least one tank to the frame ballasting and deballasting such that when ballasting occurs and the launch and recovery vehicle is in the water, the launch and recovery vehicle submerges in the water, and when deballasting occurs and the launch and recovery vehicle is in the water, the launch and recovery vehicle rises toward a water surface in the water.

14. The method of claim 13, wherein the item is an unmanned underwater vehicle.

15. The method of claim 14, wherein the frame can hold up to at least an equivalent of 20,000 pounds.

16. The method of claim 15, wherein the frame can withstand a momentum of at least an equivalent of 26,000 pounds from the item.

17. The method of claim 13, wherein a material of the portion is flexible to avoid damaging the item.

18. The method of claim 13, further comprising moving each rail of the pair of rails in an up or down position and locking in either position.

19. The method of claim 18, further comprising moving the pair of rails to touch the item such that the pair of rails and the portion hold the item and secure the item in the frame.

20. The method of claim 13, further comprising a cradle in the portion to support the item.

21. The method of claim 13, further comprising attaching the frame to a water vehicle, wherein the water vehicle pulls or tows the frame located in the water.

22. The method of claim 13, wherein each of the set of wheels has a capability to spin perpendicularly 360 degrees relative to its planar rotation.

23. The method of claim 22, wherein each of the set of wheels has a capability to lock in place to prevent spinning, but can continue its planar rotation.

24. The method of claim 13, further comprising a latching mechanism that has a latch that engages a cable device when the item moves in a parallel manner into the frame, the cable device is positioned perpendicular to a lengthwise position of the frame and is attached to either interior side of the frame.
